(19) United States
(12) Patent Application Publication
(10) Pub. No.: US 2018/0041097 A1
(43) Pub. Date: Feb. 8, 2018

(54) ROTATING POWER AMPLIFYING APPARATUS, ROTARY POWER GENERATING APPARATUS AND GENERATOR

(71) Applicant: Michihiro Kanahama, Tsuyama-shi (JP)

(72) Inventor: Michihiro Kanahama, Tsuyama-shi (JP)

(21) Appl. No.: 15/551,928

(22) PCT Filed: Dec. 24, 2015
(86) PCT No.: PCT/JP2015/086081

§ 371 Date: Aug. 18, 2017

(30) Foreign Application Priority Data
Feb. 27, 2015 (JP) 2015-037798

(51) Int. Cl. H02K 7/18; H02K 7/12; H02K 7/04; H02K 7/00

(52) U.S. Cl. CPC H02K 7/1853; H02K 7/003; H02K 7/125; H02K 7/04; F03G 3/00

(57) ABSTRACT

A rotating power amplifying apparatus includes a main shaft having a horizontally installed central axis, a main rotating body supported by the main shaft and rotatable about the central axis of the main shaft, and a repellent force generating mechanism installed around the central axis, having a repellent force generating member displaceable about the central axis, configured to displace the repellent force generating member and generate a repellent force by rotation of the main rotating body, and configured to rotate the main rotating body.

### TECHNICAL FIELD

This disclosure relates to a rotating power amplifying apparatus capable of generating electric power, and a rotary power generating apparatus and generator including the same.

### BACKGROUND

In general, as disclosed in Japanese Unexamined Patent Application Publication No. 2010-60124, as a rotating power amplifying apparatus that converts rotating energy into electric power using shaft output, an apparatus that maintains a rotational speed by surrounding a rotary shaft with rolling elements is known.

In addition, Japanese Unexamined Patent Application Publication No. 2004-124860 discloses a gravity type generator in which a counterweight is hung from a pulley and a generator rotated using a force obtained when the counterweight falls due to gravitational force (in particular, see FIG. 1). Further, PCT International Publication No. WO 2009/122683 discloses a solenoid valve using an electric double layer capacitor as a power supply.

However, since the rotating power amplifying apparatus disclosed in JP '124 converts rotating power into electric power and keeps the power generation amount below the input rotating power rather than letting it exceed the input rotating power, the rotating power amplifying apparatus is insufficient in view of efficient use of energy. In addition, JP '860 has problems in that, if the counterweight completely falls, power generation may be stopped, and the apparatus is insufficient as a continuous generator and not a stable power source. Further, WO '683 is an attempt to enable reduction in a size of an exclusive power supply to be driven, and reduction in space in a solenoid valve, and improvement of power generation efficiency and use as a stable power supply of a solenoid valve have not been studied.

Accordingly, it could be helpful to provide a rotating power amplifying apparatus capable of continuously generating electric power as a stable electric power supply source while further improving power generation efficiency of electric power obtained by rotation, and a rotary power generating apparatus and generator including the same.

### SUMMARY

We thus provide:

A rotating power amplifying apparatus includes a main shaft having a central axis that is horizontally installed; a main rotating body supported by the main shaft and rotatable about the central axis of the main shaft; and a repellent force generating mechanism installed around the central axis, having a repellent force generating member that is displaceable around the central axis, configured to displace the repellent force generating member and generate a repellent force by rotation of the main rotating body, and configured to rotate the main rotating body.

The main rotating body may include at least one balance weight that is rotatable about the central axis.

The repellent force generating mechanism may include a first magnet and a second magnet serving as the repellent force generating member and disposed concentric with each other around the central axis of the main shaft, a relative position between the first magnet and the second magnet may be displaced in the rotational direction of the main rotating body by rotation of the main rotating body, and a repellent force may be generated by a repulsive force generated between the first magnet and the second magnet.

The repellent force generating mechanism may include a spring serving as the repellent force generating member, and the spring may be displaced by rotation of the main rotating body, and a repellent force may be generated by the displaced spring.

The rotating power amplifying apparatus may include a driving gear that rotates about the central axis of the main shaft; a fixed gear fixed to the main shaft; a planetary gear that rotates about a central axis different from the central axis of the main shaft; a balance weight supported by a balance weight arm supported by a central axis of the planetary gear and rotating about the central axis of the planetary gear; and a gear case integrally fixed to the driving gear and configured to house the fixed gear and the planetary gear.

The main rotating body may include a partition spring therein and have a ball movement box having an elliptical shape and configured to house a counterweight ball.

The main rotating body may have a ball swing box having an arcuate shape and configured to house a counterweight ball, and the counterweight ball may be temporarily held in a concave section formed in the arcuate shape.

In addition, an Osmund spring may be installed at a subsidiary shaft different from the main shaft.

A rotary power generating apparatus may include the rotating power amplifying apparatus; and a rotating power output apparatus connected to the main rotating body and configured to output rotating power according to rotation of the main rotating body.

Our generator may include the rotating power amplifying apparatus; and a power generating apparatus connected to the main rotating body and configured to generate electric power according to rotation of the main rotating body.

It is thus possible to provide a rotating power amplifying apparatus capable of continuously generating electric power and remarkably improving power generation efficiency of electric power obtained by rotation, and a rotary power generating apparatus and generator including the same.

### BRIEF DESCRIPTION OF THE DRAWINGS

FIG. 1 is a view showing a rotating power amplifying apparatus including a magnet according to a first example.

FIG. 2(a) is a view showing a configuration of the rotating power amplifying apparatus according to the first example when an electromagnet is provided in a magnet holder, and FIG. 2(b) is a view showing a configuration when a permanent magnet is provided in the magnet holder.

FIGS. 3(a) to 3(c) are views showing rotation of a rotor of the rotating power amplifying apparatus according to the first example.

FIG. 4 is a view showing a rotating power amplifying apparatus including a spring according to a second example.

FIG. 5(a) is a view showing a configuration to wind and squeeze the spring in the rotating power amplifying apparatus according to the second example, and FIG. 5(b) is a view showing a configuration to release the spring.

FIG. 6 is a view showing a configuration of a cam rod in the rotating power amplifying apparatus according to the second example.

FIG. 7 is a view showing a rotating power amplifying apparatus including a gravity gear according to a third example.

FIG. 8 is a cross-sectional view in a direction of an arrow of the rotating power amplifying apparatus shown in FIG. 7.

FIG. 9(a) is a view showing a driving principle of the rotating power amplifying apparatus according to the third example, FIG. 9(b) is a view showing a configuration of a position of a maximum torque by a balance weight, and FIG. 9(c) is a view showing a position of a configuration of a minimum torque by the balance weight.

FIG. 10(a) is a view showing a front surface of a rotating power amplifying apparatus including a counterweight ball movement box according to a fourth example, and FIG. 10(b) is a view showing a side surface thereof.

FIGS. 11(a) to 11(c) are views showing operation principles of a counterweight ball and a movement box of the rotating power amplifying apparatus according to the fourth example.

FIG. 12(a) is a view showing a front surface of a rotating power amplifying apparatus including a counterweight ball swing box according to a fifth example, and FIG. 12(b) is a view showing a side surface thereof.

FIG. 13 is a view showing a configuration of the counterweight ball swing box of the rotating power amplifying apparatus according to the fifth example.

FIGS. 14(a) to 14(c) are views showing operation principles of a counterweight ball and a swing box of the rotating power amplifying apparatus according to the fifth example, and FIG. 14(d) is a view showing a trajectory of the counterweight ball.

FIG. 15(a) is a view showing a rotating power amplifying apparatus according to a sixth example when seen from above, and FIG. 15(b) is a view showing the rotating power amplifying apparatus according to the sixth example when seen from a front side.

FIG. 16 is a view showing an attachment structure of an Osmund spring.

FIGS. 17(a) and 17(b) are views showing an operation principle of the rotating power amplifying apparatus according to the sixth example.

FIG. 18 is a view showing control of a motor and movement of the balance weight when a stepping motor is used as a driving motor.

### REFERENCE SIGNS LIST

100 Rotating power amplifying apparatus
101 Housing (frame)
103 Main shaft
104 Bearing
106 Main rotating body (rotor)
111 Balance weight A
112 Balance weight arm
115 Balance weight B
116 Balance weight arm
118 Repellent force generating mechanism
121 Magnet a
123 Magnet b
126 Magnet holder
127 Magnet holder bracket
130 Magnet included in main rotating body (rotor)
131 Permanent magnet
TH1 Installation angle between balance weight arms
200 Rotating power amplifying apparatus
201 Housing (frame)
203 Main shaft
204 Bearing
206 Main rotating body
211 Balance weight
212 Balance weight arm
221 Gear a
222 Gear b
223 Gear a′
224 Gear b′
230 Repellent force generating mechanism
231 Spring
241 Main shaft pin
242 Gear b pin
250 Cam mechanism
251 Cam
252 Cam pin
253 Cam rod
254 Cam rod receiving hole
256 Thrust bearing
257 Radial thrust bearing
261 Subsidiary shaft
262 Subsidiary shaft pin
263 Subsidiary shaft pin guide
300 Rotating power amplifying apparatus
301 Housing (frame)
303 Main shaft
306 Main rotating body (rotor)
311 Balance weight
312 Balance weight arm
321 Driving gear
323 Gear case
324 Fixed gear
325 Idler
326 Idler shaft
328 Planetary gear
331 Bearing
332 Main shaft fixing bracket
341 Planetary gear shaft
351 Main shaft center vertical line
352 Planetary gear center trajectory
353 Balance weight center trajectory
400 Rotating power amplifying apparatus
401 Housing (frame)
403 Main shaft
404 Bearing
406 Disk-shaped rotor
411 Counterweight ball movement box
412 Partition spring
415 Counterweight ball
421 Disk-shaped rotor center vertical line
422 Disk-shaped rotor outer edge (perfect circle)
500 Rotating power amplifying apparatus
501 Housing (frame)
503 Main shaft
504 Bearing
506 Disk-shaped rotor
511 Counterweight ball swing box
512 Counterweight ball swing box inner circumferential section
513 Counterweight ball swing box outer edge portion
514 Counterweight ball receiving section
515 Counterweight ball
521 Disk-shaped rotor center vertical line
522 Disk-shaped rotor outer circumferential circle (perfect circle)
600 Rotating power amplifying apparatus
601 Housing (frame)
603 Main shaft
607 Main shaft gear
611 Balance weight
612 Balance weight arm
621 Bearing a
622 Bearing b
623 Bearing
625 Subsidiary shaft
626 Subsidiary shaft gear
628 Drive transmission gear
629 Speed adjustment gear
631 Spring case
632 Spring case gear
633 Spring case cover
634 Osmund spring
641 Main shaft gear reference pitch circle
642 Subsidiary shaft gear reference pitch circle
643 Spring case gear reference pitch circle
644 Drive transmission gear reference pitch circle
645 Speed adjustment gear reference pitch circle
651 Driving motor
652 Acceleration zone
653 Constant speed zone
654 Deceleration zone
655 Rotation stoppage/electric conduction minimum zone
656 Rotation of both of balance weight and spring case gear
657 Rotation of balance weight only
661 Motor control box
663 Rotation sensor

### DETAILED DESCRIPTION

A rotating power amplifying apparatus according to examples, and a rotary power generating apparatus and generator including the rotating power amplifying apparatus will be described below.

### First Example

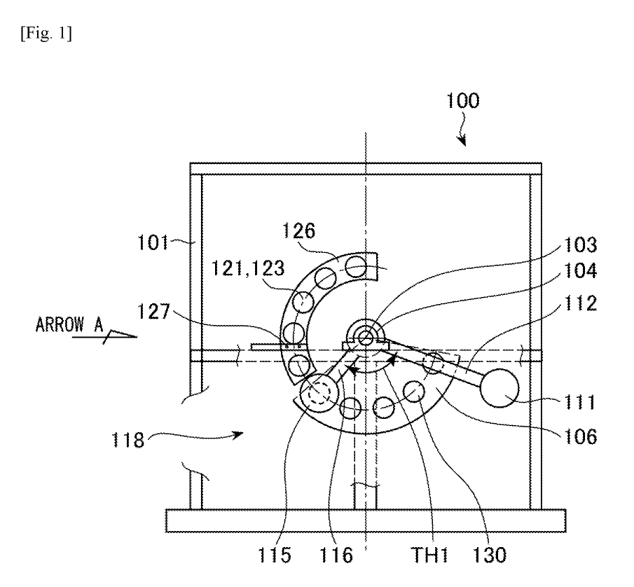

FIG. 1 shows a rotating power amplifying apparatus 100 according to the first example.

The rotating power amplifying apparatus 100 according to the first example includes a main shaft 103, a main rotating body (hereinafter referred to also as “a rotor”) 106 rotated about the main shaft 103, a plurality of balance weights 111 and 115 axially supported by the main shaft 103 and rotatable about the main shaft 103, a magnet 130 installed at the main rotating body 106 and rotatable about the central axis about which the main rotating body 106 rotates, a magnet holder 126 disposed concentrically with a central axis about which the main rotating body 106 rotates, and magnets 121 and 123 installed in the magnet holder 126.

The magnet holder 126 holds the magnet 130 from both sides, is disposed in the same concentric circular shape as the magnet 130 with respect to the central axis about which the main rotating body 106 rotates, and is fixed to a frame 101.

The rotating power amplifying apparatus 100 according to the first example includes the magnet 130 and a repellent force generating mechanism 118 configured to generate a repellent force by a repulsive force generated between the magnets 121 and 123.

The rotating power amplifying apparatus 100 according to the first example amplifies a rotating power using a falling moment of the balance weight and a repellent force of the magnets generated by the repellent force generating mechanism 118.

The rotating power amplifying apparatus according to the first example will be further described below.

In the rotating power amplifying apparatus 100 according to the first example, the main shaft 103 is installed at the frame 101 via a bearing such that a central axis thereof is horizontal. The main shaft 103 is rotatable about the central axis, and is used to add a starting torque to the apparatus of the example and extract shaft output. The main rotating body 106 rotates about a rotational center axis shared with the main shaft 103. Accordingly, the main rotating body 106 rotates about the main shaft 103.

The balance weights 111 and 115 are counterweights attached to tips of balance weight arms 112 and 116. The balance weights are fixed to the main shaft by the balance weight arms and rotated with the main shaft. Lengths of the balance weight arms are set to specified lengths that are different from each other. For example, lengths of a balance weight arm 112 of a balance weight A 111 and a balance weight arm 116 of a balance weight B 115 are set to the length of the arm of the balance weight A:the length of the arm of the balance weight B=2:1. Further, the balance weight may be formed of a material having weight. The balance weight may be formed of, for example, iron.

In the balance weight arms 112 and 116, when each of the balance weight arms 112 and 116 is raised to attenuate interference with a rotating power of the main shaft 103, the balance weight arms 112 and 116 are preferably installed at a specified opening angle TH1. For example, the specified opening angle TH1 of the balance weight arms 112 and 116 is 110 degrees.

Next, the repellent force generating mechanism 118 configured to generate a repellent force by the magnets will be described.

The rotor 106 configured to hold the magnet 130 is fixed to the main shaft 103 and rotated with the main shaft 103. For example, a permanent magnet 131 is used as the magnet 130 held at the rotor 106. The rotor 106 is disposed not to interfere with rotation of the balance weight arms 112 and 116. Then, when the magnet 130 is the permanent magnet 131, a plurality of permanent magnets 131 are present, and the plurality of permanent magnets 131 are disposed in a fan shape on a circle concentric with the main shaft at equal intervals as a whole. A fan-shaped disposition angle of the permanent magnets 131 (an angle formed between centers of the permanent magnets 131 of both ends and the central axis) is preferably equal to the opening angle TH1 of the balance weight arms 112 and 116. The magnet 130 may also be an electromagnet.

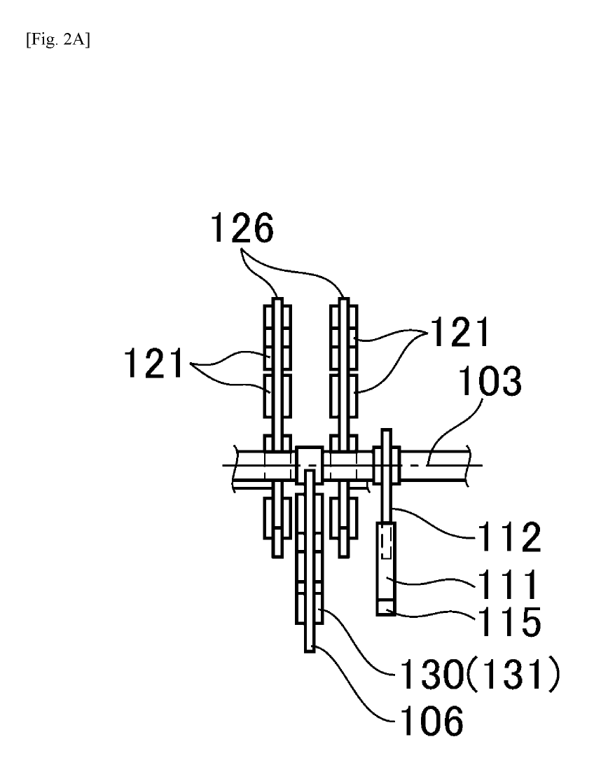

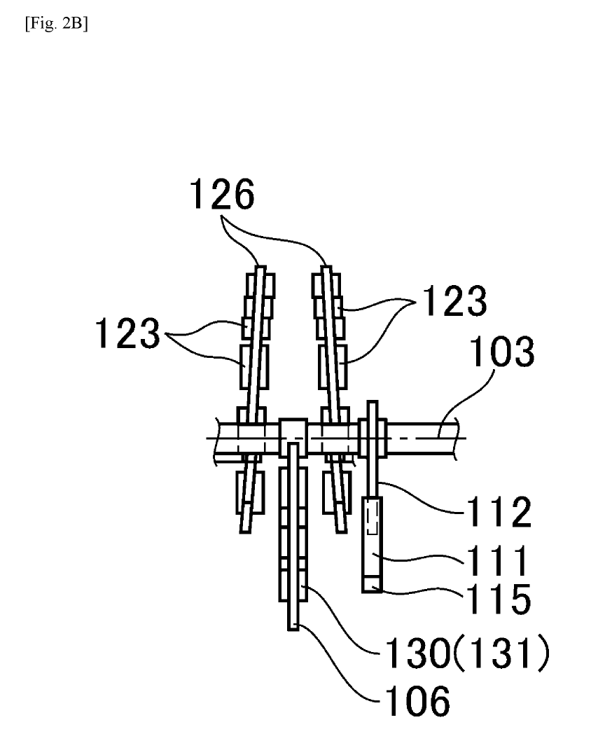

FIGS. 2(a) and 2(b) are views when seen from an arrow A of FIG. 1. FIG. 2(a) shows a configuration of the rotating power amplifying apparatus of the example when magnets a 121 serving as electromagnets are installed in the magnet holder, and FIG. 2(b) shows a configuration when magnets b 123 serving as permanent magnets are installed in the magnet holder.

As shown in FIGS. 1, 2(a) and 2(b), the magnet holder 126 is disposed at a position at which it holds the rotor from both sides when the rotor 106 is rotated. The positions at which the magnet holder 126 is disposed with respect to the main shaft 103 is a position at which gravitational forces of the balance weight A 111 and the balance weight B 115 generate a rotational moment in a direction opposite to a rotational direction of the apparatus of the example. Specifically, in FIG. 1, the magnet holder 126 is preferably disposed at positions from 12 o'clock to 8 o'clock on a clock face.

The magnets a 121 serving as the electromagnets or the magnets b 123 serving as the permanent magnets are disposed in the magnet holder 126. The magnets a 121 or the magnets b 123 are disposed in a fan shape at equal intervals to form a circle concentric with the magnet 130 in the rotor serving as the permanent magnet. The magnets a 121 or the magnets b 123 in the magnet holder 126 are disposed to face the same polarity as the magnet 130 in the rotor when the magnet 130 passes through the magnet holder 126.

As shown in FIG. 2(a), when the magnets a 121 serving as the electromagnets are installed in the magnet holder 126, the rotor 106 and the magnet holder 126 are preferably disposed in parallel to and adjacent to each other.

As shown in FIG. 2(b), when the magnets b 123 serving as the permanent magnets are installed in the magnet holder 126 to attenuate repulsion generated when the permanent magnets in the rotor 106 approach each other while rotating, the magnet holder 126 is preferably disposed in a truncated chevron shape with respect to the main shaft 103 such that a distance between sides of the magnet holder 126 is reduced away from the main shaft 103. Even when the magnet holder 126 is disposed at the main shaft 103 in the truncated chevron shape, surfaces in which the magnets b 123 and the permanent magnets in the magnet holder 126 are opposite to each other are preferably disposed in parallel to each other.

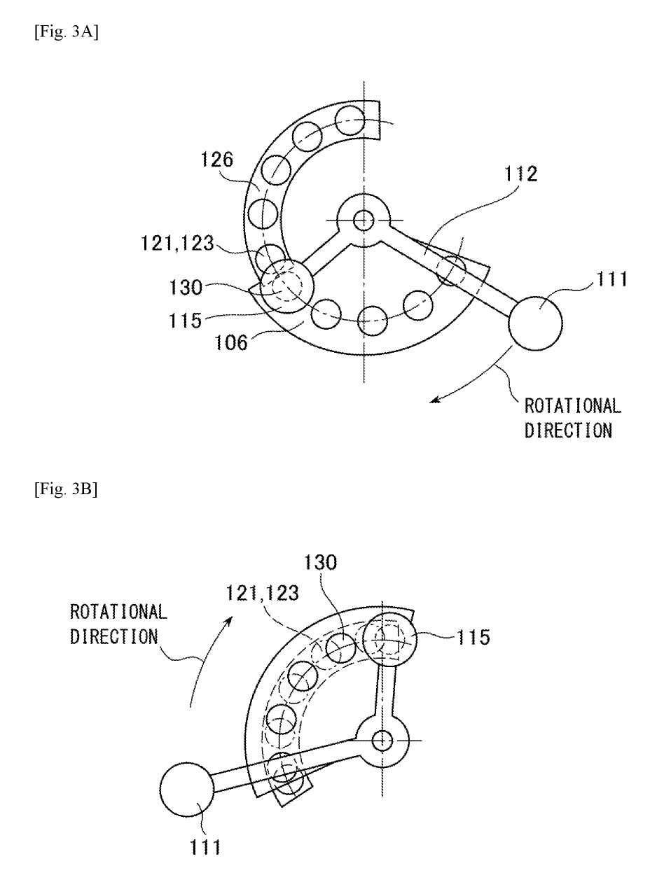

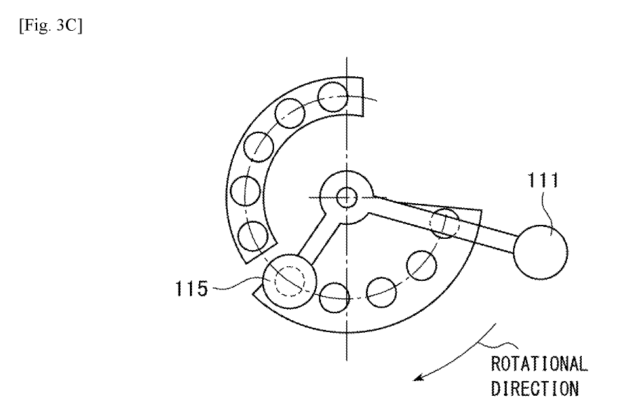

Referring to FIGS. 3(a) to 3(c), an operation of the rotating power amplifying apparatus according to the first example will be described.

Gravitational force is applied to both of the balance weight A 111 and the balance weight B 115 in the rotational direction, and rotational movement is accelerated by the gravitational force applied to the balance weight A 111 and the balance weight B 115 at the position at which the rotational moment occurs in the rotational direction.

A magnet 131 in the rotor can push the rotor 106 in the magnet holder 126 in the rotational direction even when a repulsive force occurs between the magnet in the rotor and the magnets in the magnet holder because the balance weight A 111 has the largest value of the rotational moment with respect to the rotational direction at a position at which the magnet 131 in the rotor is adjacent to the magnets a 121 or the magnets b 123 in the magnet holder 126 (see FIG. 3(a)).

As the magnets a 121 serving as the electromagnets are excited such that the magnets face the same polarity as the surface of the permanent magnet in the rotor 106 at the position at which the balance weight A 111 generates a rotational moment opposite to the rotational direction, rotation can be maintained by the repulsive force generated between the magnets a 121 and the magnet 130 in the rotor 106. A force generated by inertia of the balance weight B 115 also promotes rotation (see FIG. 3(b)).

The balance weight arm 112 of the balance weight A 111 is longer than the balance weight arm 116 of the balance weight B 115 at the position at which the balance weight B 115 generates the rotational moment opposite to the rotational direction. For this reason, a difference between the rotational moment of the balance weight A 111 and the balance weight arm 112 and the rotational moment of the balance weight B 115 and the balance weight arm 116 contributes to maintaining rotation (see FIG. 3(c)).

As described above, the rotating power amplifying apparatus according to the first example can amplify a rotating power using a falling moment of the balance weight and a repellent force of the magnet. That is, it is possible to provide a rotating power amplifying apparatus capable of generating electric power substantially continuously and remarkably improving power generation efficiency of electric power obtained by rotation while applying little starting energy.

### Second Example

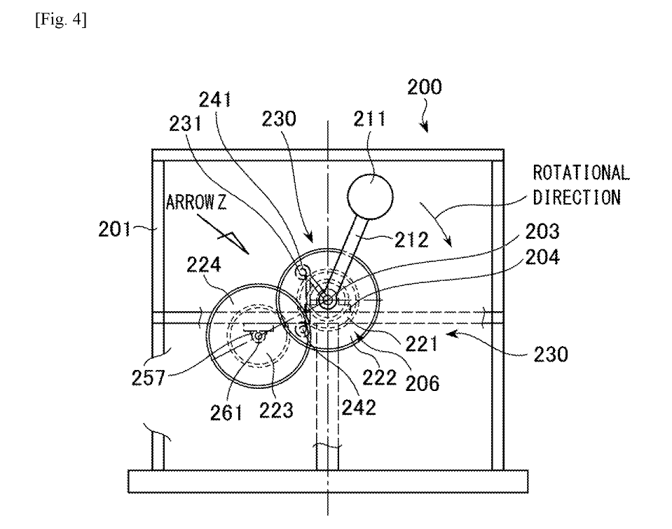

FIG. 4 shows a rotating power amplifying apparatus 200 according to the second example.

The rotating power amplifying apparatus 200 according to the second example includes a main shaft 203, a main rotating body 206 serving as a rotating target that rotates about the main shaft 203, a balance weight 211 and a balance weight arm 212, which are axially supported by the main shaft 203, constituting a portion of the main rotating body 206 and rotatable about the main shaft 203, a gear a 221 that is axially supported like the balance weight 211 and the balance weight arm 212, a gear b 222 rotatably attached to the main shaft 203, a spring 231 having a coil spring shape and attached to the gear b 222, a cam mechanism 250 configured to fix the gear b 222 such that the spring 231 is wound and squeezed and release the gear b 222 such that the spring 231 is released, and a gear a′ 223 and a gear b′ 224 configured to receive rotating power to cause the spring 231 to be wound and unwound, in a specified disposition.

That is, the rotating power amplifying apparatus according to the second example includes a repellent force generating mechanism 230 configured to generate a repellent force by the spring 231 to be wound and then unwound.

The rotating power amplifying apparatus according to the second example amplifies a rotating power using a falling moment of the balance weight and a repellent force of the spring generated by the repellent force generating mechanism 230.

The rotating power amplifying apparatus according to the second example will be further described below.

The main shaft 203 is rotatably installed at a frame 201 via a bearing 204 such that a central axis of rotation thereof is horizontal. The main shaft 203 is used to add a starting torque to the apparatus of the example or extract the shaft output.

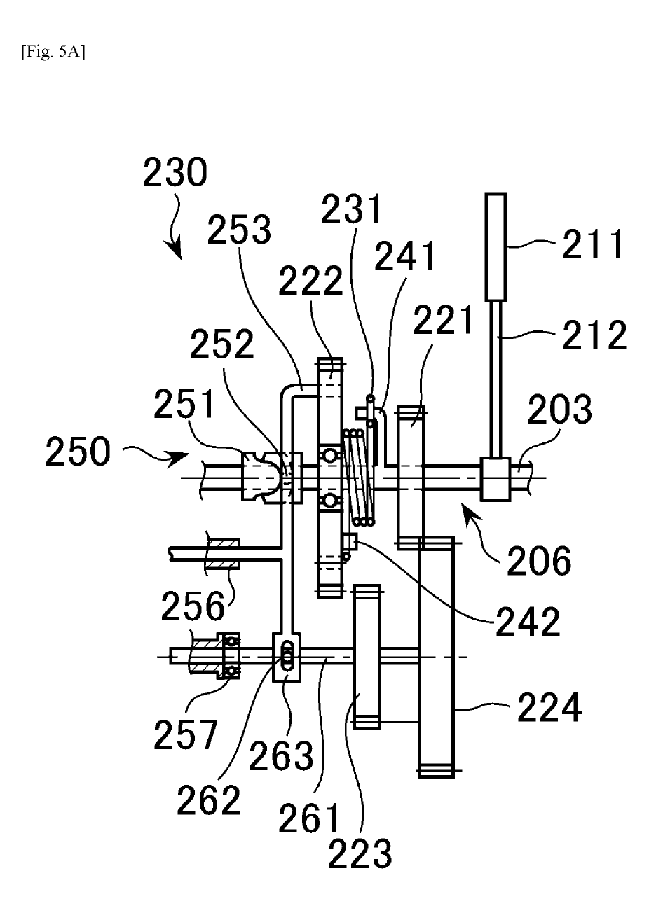

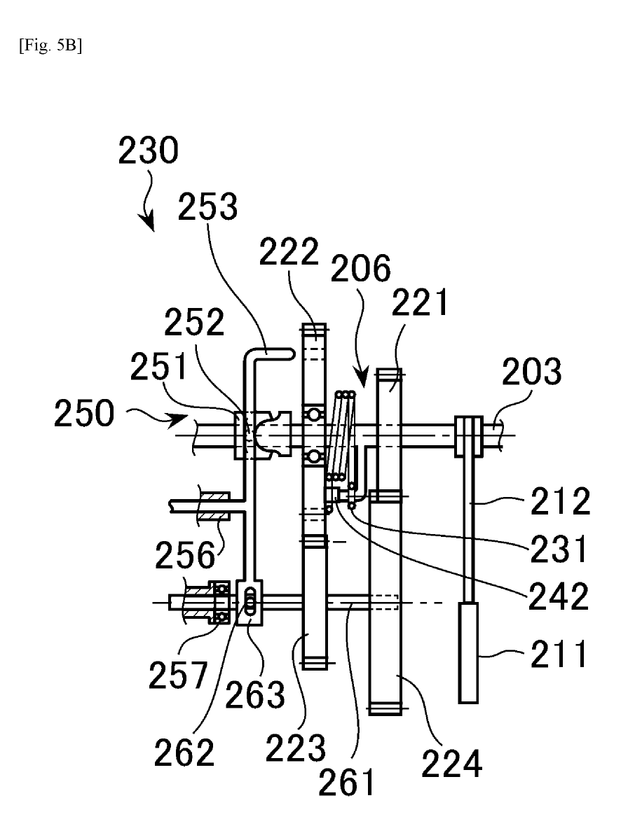

As shown in FIGS. 4 and 5(a) to 5(b), the gear a 221 and the gear a′ 223 have the same pitch diameter and module, and the gear b 222 and the gear b′ 224 have the same pitch diameter and module and different tooth thicknesses. The gear a 221 is fixedly disposed at the main shaft 203. On the other hand, the gear b 222 is disposed rotatably with respect to the main shaft 203.

As shown in FIGS. 5(a) and 5(b) (FIG. 5 is a view seen from an arrow Z of FIG. 4), a gear b pin 242 is installed on the gear b 222, and a main shaft pin 241 is formed on the main shaft 203. The spring 231 is installed such that an end portion of the spring 231 is held by the gear b pin 242 and the main shaft pin 241, and a center of a spiral section of the spring 231 coincides with the main shaft 203.

When the spring 231 is shown with reference to FIG. 4, the spring 231 is installed at the gear b 222 such that the center of the spiral section coincides with the main shaft 203.

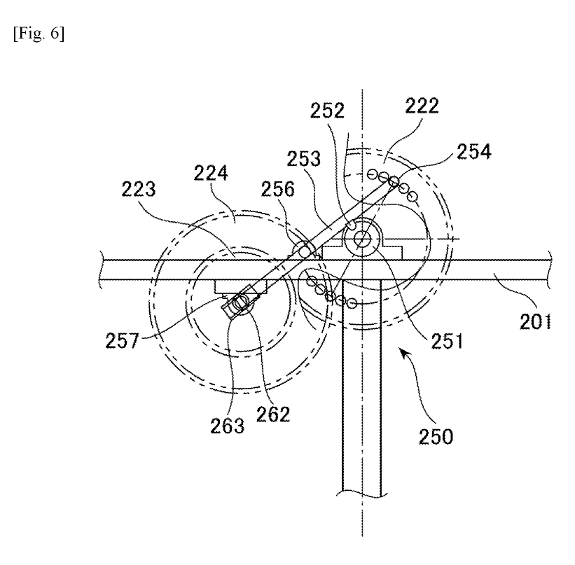

FIG. 6 shows a configuration of the cam mechanism 250. As shown in FIG. 6, a cam 251 is fixed to the main shaft 203. In addition, a hole 254 that receives a cam rod 253 is perforated in the gear b 222 in a circular shape concentric with the main shaft 203. Rotation of the balance weight A 211 is promoted by the gravitational force working on the balance weight A 211 at the position at which a balance weight A 211 generates an effective rotational moment in the rotational direction. In addition, since the gear b 222 is fixed onto the main shaft 203 via the cam rod 253 by the cam 251 at that position, the spring 231 is wound and squeezed by the main shaft pin 241. In the example, the spring 231 is wound and squeezed to, for example, 180 degrees.

At the position at which the balance weight A 211 generates a rotational moment against the rotational direction, since the cam rod 253 is removed from the gear b 222 by the cam 251, the gear b 222 obtains the rotating power in the rotational direction via a gear pin by a releasing power of the spring 231.

In the example, the cam rod 253 is attached to the frame 201 by a thrust bearing 256 and a radial thrust bearing 257. The thrust bearing 256 moves in a thrust direction, and the radial thrust bearing 257 bears a rotating power of a subsidiary shaft 261 and a thrust load in an axial direction. In this way, by thrusting the subsidiary shaft 261 in a bearing direction, the gear b 222 and the gear a′ 223 are meshed. At the position at which the balance weight A 211 generates the rotational moment against the rotational direction, the subsidiary shaft 261 is moved by the cam 251, and the gear b 222 and the gear a′ 223 are meshed and moved. A cam pin 252 that has entered the groove of the cam 251 moves the cam rod 253 (in FIG. 5, moves the cam rod 253 right/left) to engage the gears with each other or release engagement therebetween.

Both the gear a′ 223 and the gear b′ 224 are fixed to the subsidiary shaft 261. In addition, the gear b′ 224 and the gear a 221 on the main shaft 203 are installed to be meshed under normal circumstances. Accordingly, rotation of the gear a 221 and the gear a′ 223 is synchronized. If the groove of the cam 251 is appropriately set, when the cam rod 253 is removed from the gear b 222 by the cam 251, the gear b 222 and the gear a′ 223 are meshed. Accordingly, the releasing power of the spring 231 is transmitted to the gear a′ 223 via the gear b 222, and a force of raising the balance weight 211 in a rotational direction can be obtained.

In this way, in the rotating power amplifying apparatus according to the second example, the balance weight can be rotated to obtain effective rotating power by the gravitational force working on the balance weight A at the position at which the balance weight A generates the rotational moment effective in the rotational direction and by a winding/squeezing repellent force of the spring at the position at which the balance weight A generates the rotational moment against the rotational direction.

As described above, the rotating power amplifying apparatus according to the second example can amplify the rotating power using the falling moment of the balance weight and the winding/squeezing repellent force of the spring. That is, it is possible to provide the rotating power amplifying apparatus capable of generating electric power substantially continuously and remarkably improving power generation efficiency of electric power obtained by rotation while applying little starting energy.

### Third Example

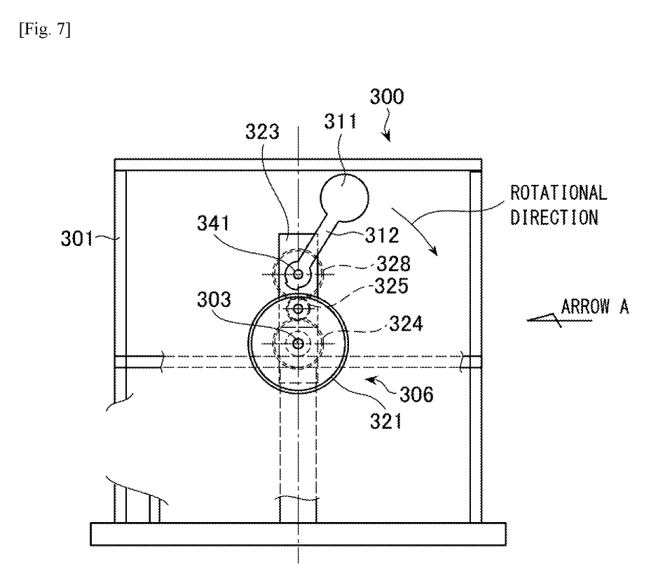

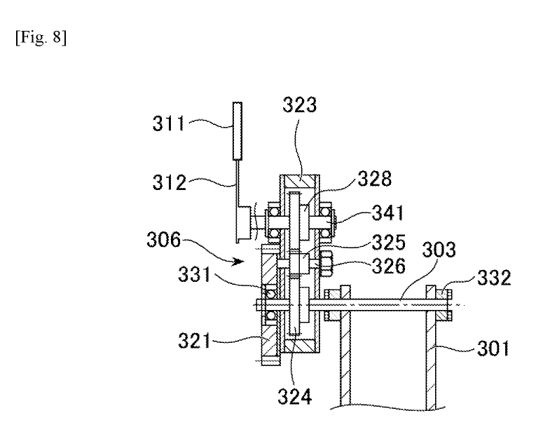

FIG. 7 shows a rotating power amplifying apparatus 300 according to a third example.

The rotating power amplifying apparatus 300 according to the third example includes a gear case 323 fixed to a rotating body serving as a rotating target that rotates about a main shaft 303, one gear fixed to the main shaft and installed in the gear case 323 that rotates about the main shaft, a planetary gear 328 that is installed in the gear case 323 and rotates about a planetary gear shaft different from the main shaft 303, and a balance weight 311 that rotates about the planetary gear shaft.

The rotating power amplifying apparatus according to the third example continues rotation by rotating the balance weight at an advantageous position at which the rotating power is generated using a combination of the dropping rotational moment of the balance weight and the gear.

In the rotating power amplifying apparatus 300 according to the third example, a driving gear 321 and the gear case 323 are integrated, and when a starting torque is applied to the apparatus or when the shaft output is extracted from the apparatus, the driving gear 321 is used.

The main shaft 303 is horizontally fixed to a frame 301 via a fixing bracket. A fixed gear 324, an idler (gear) 325 and the planetary gear 328 are combined and installed in the gear case 323. The driving gear 321, the gear case 323 and the fixed gear 324 that rotate about the main shaft constitute a main rotating body (a rotor) 306 fixed to the main shaft and rotating about the main shaft.

The fixed gear 324 and the planetary gear 328 have the same pitch diameter and module. In addition, the fixed gear 324 and the planetary gear 328 also preferably have the same tooth thickness. The module of the idler 325 coincides with another gear.

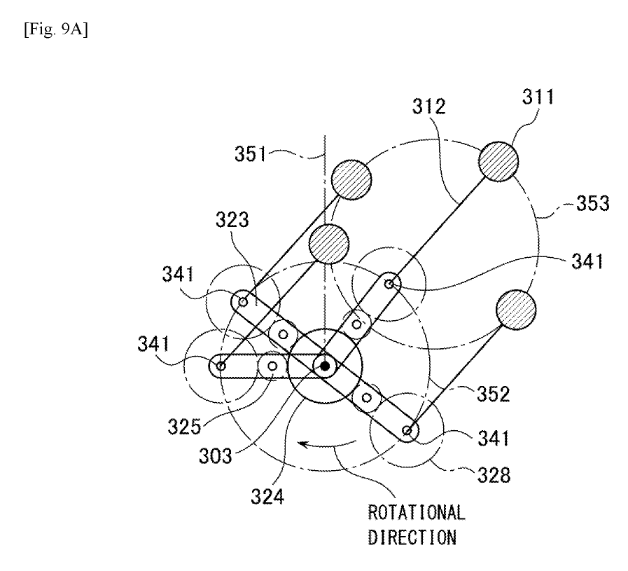

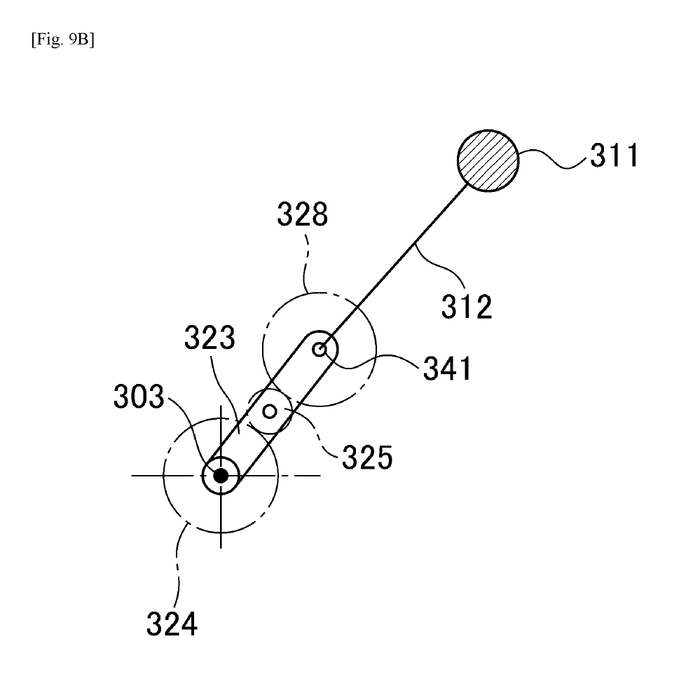

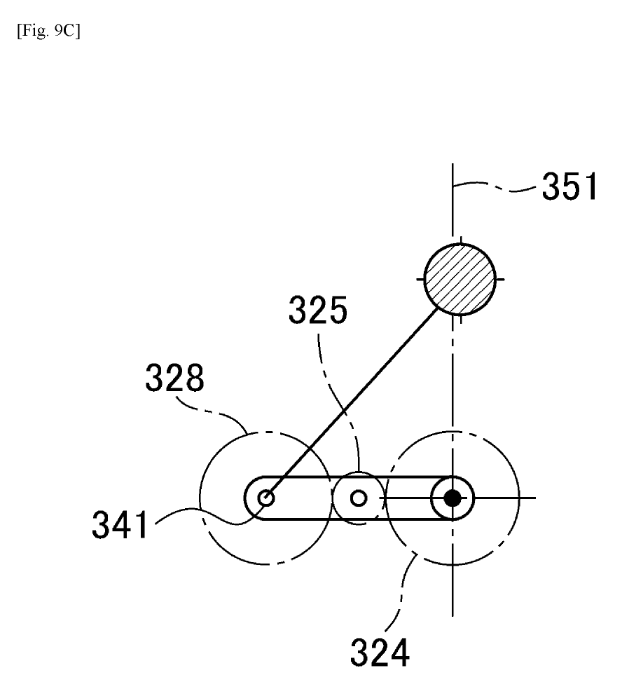

Next, an operation of the rotating power amplifying apparatus according to the third example and a structure that generates a driving force will be described with reference to FIGS. 9(a) to 9(c).

FIG. 9(a) shows positions of one period of rotating operations of the balance weight 311 and a balance weight arm 312 of the rotating power amplifying apparatus according to the third example.

The planetary gear 328 is fixed to a planetary gear shaft 341, and rotates about the planetary gear shaft 341 as a central axis. Then, the balance weight arm 312 is fixed to the planetary gear shaft 341 configured to fix the planetary gear 328, and the balance weight 311 attached to tips of the balance weight arm 312 and the balance weight arm 312 are rotated using the planetary gear shaft 341 as a central axis of rotation of the balance weight arm 312.

The fixed gear 324 and the planetary gear 328 are not affected by a pitch circle of the idler 325 because structures of the teeth are identical to each other. For this reason, in the planetary gear shaft 341 serving as the central axis of the planetary gear 328, an angle formed by a longitudinal direction of the balance weight arm 312 and a horizontal plane is not varied, regardless of the rotational position at which the gear case 323 is disposed. That is, an attachment angle with respect to the horizontal plane in the longitudinal direction of the balance weight arm 312 with respect to the planetary gear shaft 341 is not varied, regardless of the rotational position at which the gear case 323 is disposed, and an attachment angle initially set to the horizontal plane in the longitudinal direction of the balance weight arm 312 with respect to the planetary gear shaft 341 is maintained.

As shown in FIG. 9(a), in the rotating power amplifying apparatus according to the third example, when the balance weight 311 and the gear case 323 are rotated, the balance weight 311 is rotated along a balance weight center trajectory 353.

As described above, the attachment angle with respect to the horizontal plane in the longitudinal direction of the balance weight arm 312 with respect to the planetary gear shaft 341 is not varied, regardless of the rotational position at which the gear case 323 is disposed, and the attachment angle initially set to the horizontal plane in the longitudinal direction of the balance weight arm 312 with respect to the planetary gear shaft 341 is maintained.

In this way, since an angle with respect to the horizontal plane in the longitudinal direction of the balance weight arm 312 is maintained, the rotational moment of the balance weight 311 and the balance weight arm 312 is zero or a positive value with respect to the rotational direction with reference to the main shaft 303.

FIG. 9(b) shows a position at which the balance weight 311 generates the largest rotational moment in the rotational direction of the gear case 323.

In addition, FIG. 9(c) shows a position at which the balance weight 311 generates the smallest rotational moment in the rotational direction of the gear case 323. A value of the rotational moment is a non-negative value in the rotational direction even at a position at which the smallest rotational moment occurs. Accordingly, in the rotating power amplifying apparatus according to the example, the balance weight 311 does not generate a rotational moment opposite to the rotational direction with respect to the main shaft 303.

As described above, the balance weight 311 is disposed at a position at which the rotational moment is zero or positive in the rotational direction when seen from a main shaft core (the main shaft 303) at positions of the balance weight center trajectory 353. Accordingly, the gear case 323 and the driving gear 321 can obtain excellent rotation efficiency.

As described above, the rotating power amplifying apparatus according to the third example can amplify the rotating power using a combination of the falling moment of the balance weight and the gear. That is, it is possible to provide the rotating power amplifying apparatus capable of generating electric power substantially continuously and remarkably improving power generation efficiency of electric power obtained by rotation while applying little starting energy.

### Fourth Example

FIGS. 10(a) and 10(b) show a rotating power amplifying apparatus 400 according to the fourth example.

The rotating power amplifying apparatus 400 according to the fourth example includes a disk-shaped rotor 406 axially supported at a position of a main shaft 403 of a rotating body serving as a rotating target, a counterweight ball movement box 411 fixed to the disk-shaped rotor 406 and configured to receive a counterweight ball 415, and a partition spring 412 installed in the counterweight ball movement box 411.

The rotating power amplifying apparatus 400 according to the fourth example can house the counterweight ball 415 in the counterweight ball movement box 411 including the partition spring 412 therein, and amplify a rotating power using gravitational force and a centrifugal force of the counterweight ball 415.

In the rotating power amplifying apparatus 400 according to the fourth example, the main shaft 403 serving as a central axis is horizontally installed at a frame 401 via a bearing 404. The main shaft 403 is used to apply a starting torque to the apparatus of the example or extract the shaft output.

The counterweight ball 415 is formed of a material having weight in a spherical shape. In the example, the counterweight ball 415 is, for example, an iron ball.

The counterweight ball movement box 411 is formed of a material capable of withstanding movement of the counterweight ball 415. When seen from a front view of FIG. 10(a), the counterweight ball movement box 411 is formed in an elliptical shape. The counterweight ball 415 can easily move in an upward/downward direction. In addition, as shown in FIG. 10(b), a clearance between a wall surface of the counterweight ball movement box 411 and the counterweight ball 415 in the forward/rearward direction can be decreased.

As shown in FIG. 10(a), the partition spring 412 is fixed to an elliptical inner surface having a gentle curvature of the counterweight ball movement box 411 having an elliptical shape. The partition spring 412 is formed of a material that can withstand repeated loads applied by the counterweight ball 415. A spring repellent force of a tip portion of the partition spring 412 is preferably set to be weaker than a spring repellent portion of a fixing base portion of the partition spring 412. In the example, the partition spring 412 is formed of, for example, a stainless spring material.

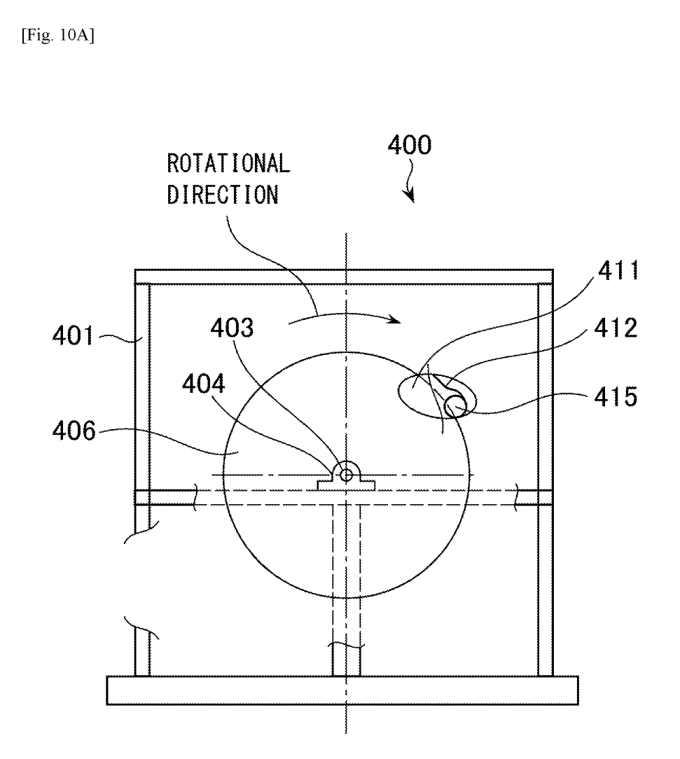

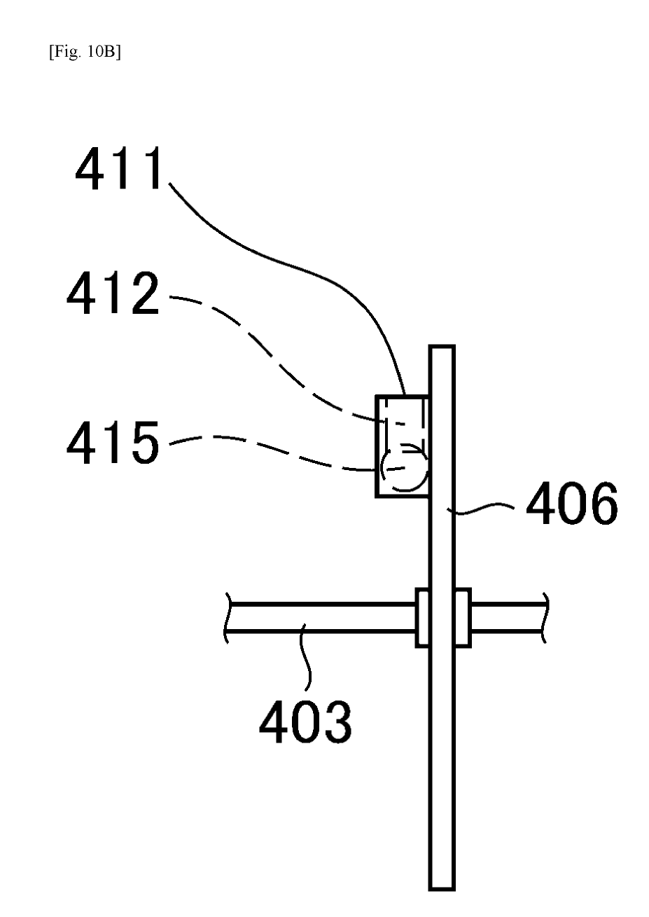

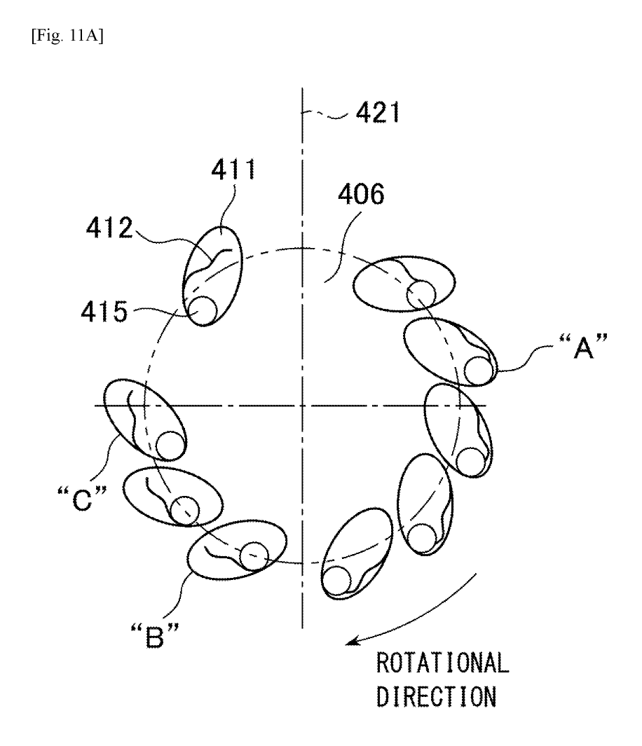

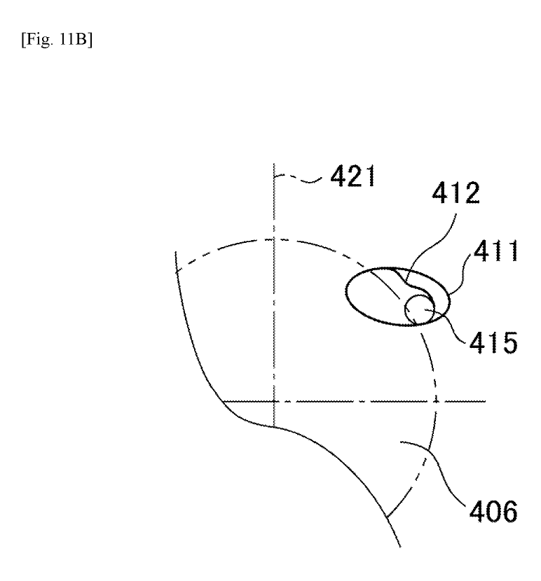

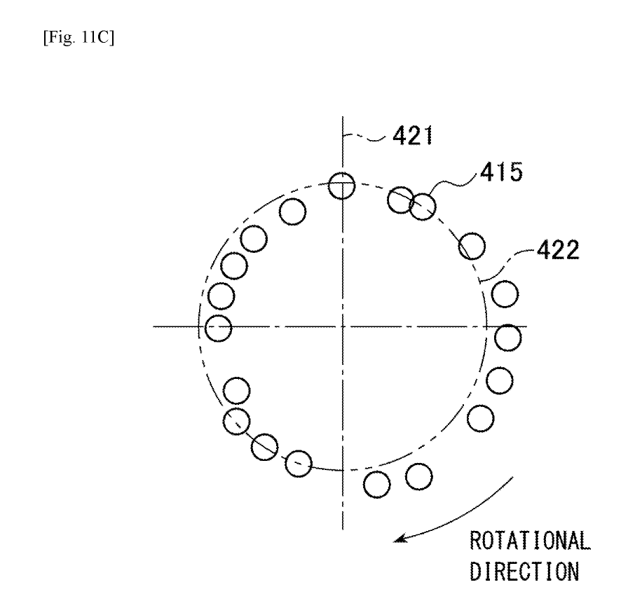

Operations of the counterweight ball 415 and the counterweight ball movement box 411 of the rotating power amplifying apparatus according to the fourth example will be described with reference to FIGS. 11(a) and 11(b).

As shown in FIG. 11(a), when the disk-shaped rotor 406 is rotated in the rotational direction, the counterweight ball 415 in the counterweight ball movement box 411 is pressed against the wall surface of the counterweight ball movement box 411 by the gravitational force and the centrifugal force at a position A of FIG. 11(a) at a right side of a disk-shaped rotor center vertical line 421 in the drawing. Then, when the disk-shaped rotor 406 is further rotated and the counterweight ball 415 enters a left side of the disk-shaped rotor center vertical line 421 in the drawing, the counterweight ball is scooped up by the partition spring 412 at a position B of FIG. 11(a) and dropped below the wall surface of the counterweight ball movement box 411. Next, the counterweight ball 415 is rotated with the disk-shaped rotor 406 while moving along the wall surface of the counterweight ball movement box 411 by gravitational force and an inertial force at a position C of FIG. 11(a).

FIG. 11(c) shows a trajectory of the counterweight ball 415 in the rotating power amplifying apparatus according to the fourth example.

As shown by the trajectory of the counterweight ball 415 of FIG. 11(c), the rotational moment exerted on the main shaft 403 of the counterweight ball 415 is larger at the right side of the disk-shaped rotor center vertical line 421 in the drawing than at the left side in the drawing. Accordingly, in the rotating power amplifying apparatus according to the fourth example, as the revolving speed at which the gravitational force of the counterweight ball 415 effectively works is appropriately selected, rotation efficiency of the disk-shaped rotor 406 can be increased, and rotating power of the disk-shaped rotor 406 can be largely amplified.

### Fifth Example

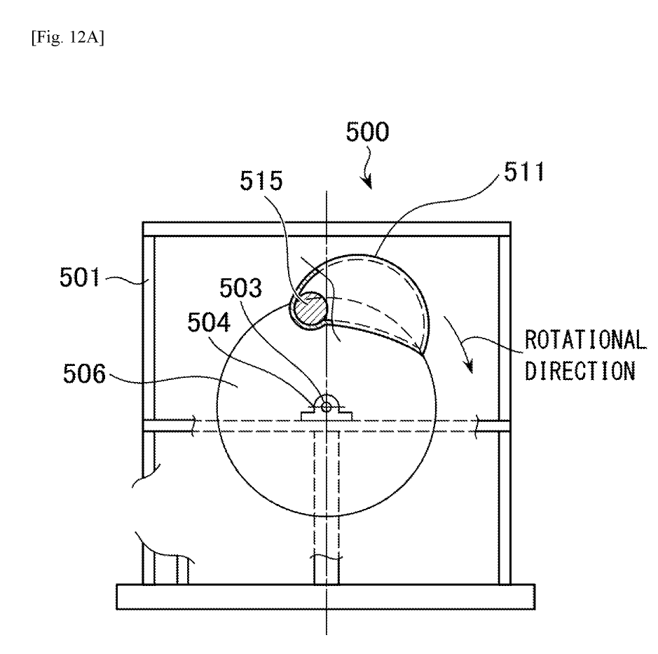

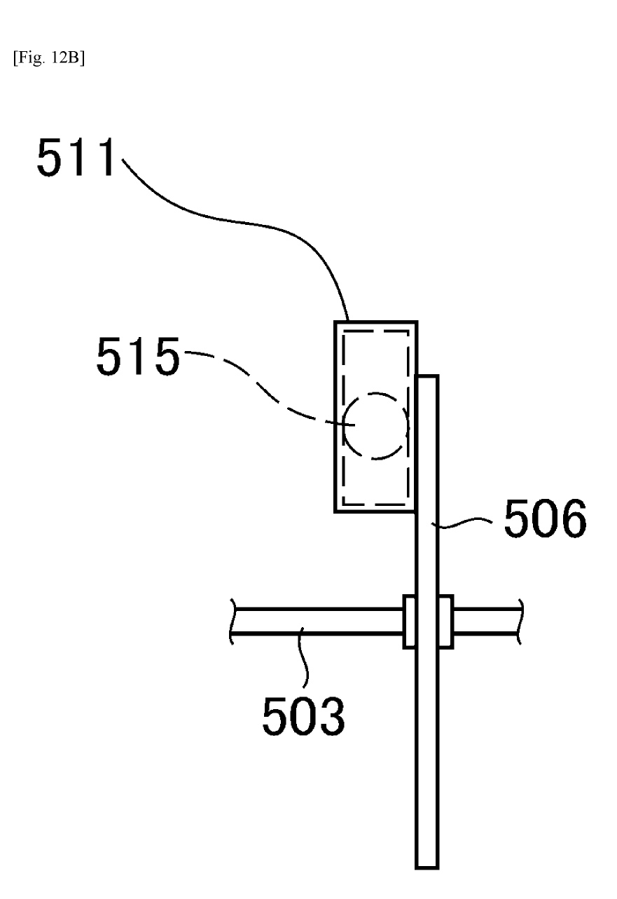

FIGS. 12(a) and 12(b) show a rotating power amplifying apparatus 500 according to a fifth example.

The rotating power amplifying apparatus 500 according to the fifth example includes a disk-shaped rotor 506 axially supported at a position of a main shaft 503 of a rotating body serving as a rotating target, and a counterweight ball swing box 511 fixed to the disk-shaped rotor 506 and configured to receive a counterweight ball 515, and the counterweight ball swing box 511 includes a counterweight ball receiving section 514 therein.

The rotating power amplifying apparatus 500 according to the fifth example can house the counterweight ball 515 in the shape of a concave section adjacent to an arcuate chord, an arc, and an intersection at which the chord and the arc intersect, which are formed in the counterweight ball swing box 511, and amplify the rotating power using gravitational force and a centrifugal force of the counterweight ball 515.

In the rotating power amplifying apparatus 500 according to the fifth example, the main shaft 503 serving as the central axis is horizontally installed at a frame 501 via a bearing 504. The main shaft 503 is used to add the starting torque to the apparatus of the example and extract the shaft output.

The counterweight ball 515 is formed of a material having weight in a spherical shape. In the rotating power amplifying apparatus of the example, the counterweight ball 515 is, for example, an iron ball.

The counterweight ball swing box 511 is formed of a material capable of withstanding movement of the counterweight ball 515. When seen from a front surface of FIG. 12(a), the counterweight ball 515 can easily move in the upward/downward direction. In addition, as shown in FIG. 12(b), a clearance between a wall surface of the counterweight ball swing box 511 and the counterweight ball 515 can be decreased in the forward/rearward direction.

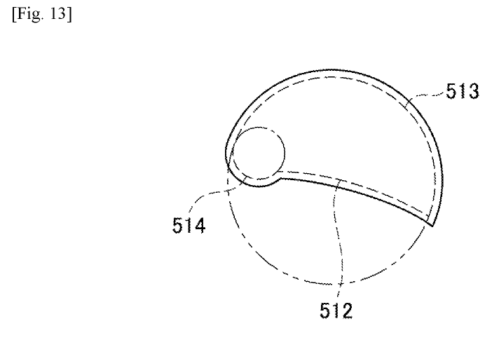

As shown in FIG. 13, the counterweight ball swing box 511 of the rotating power amplifying apparatus of the example includes a concave section adjacent to an intersection of an arcuate chord and an arc, i.e., one side of an intersection between an inner circumferential section 512 and an outer edge portion 513 of the counterweight ball swing box 511. The concave section is the counterweight ball receiving section 514 configured to temporarily hold the counterweight ball.

Operations of the counterweight ball and the counterweight ball swing box of the rotating power amplifying apparatus of the fifth example will be described.

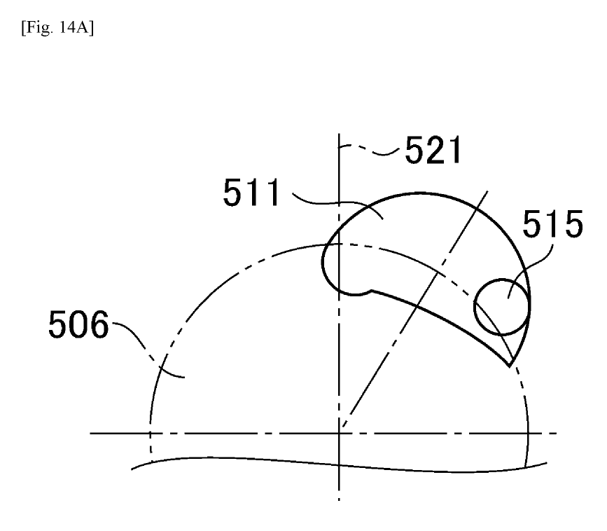

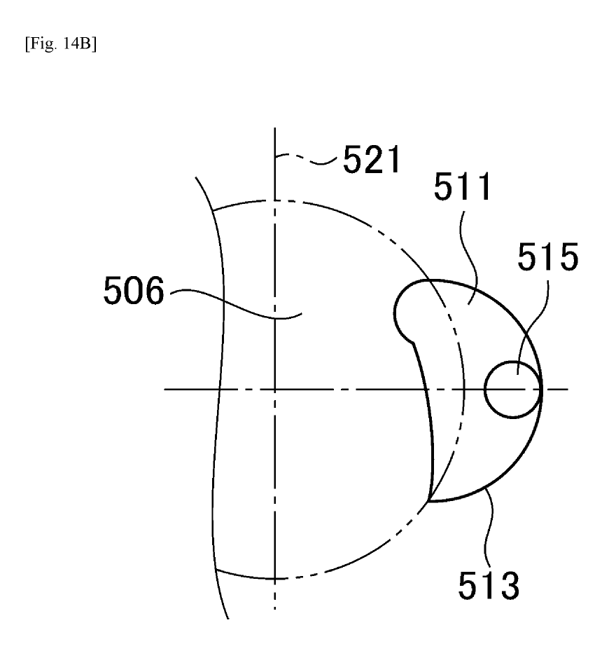

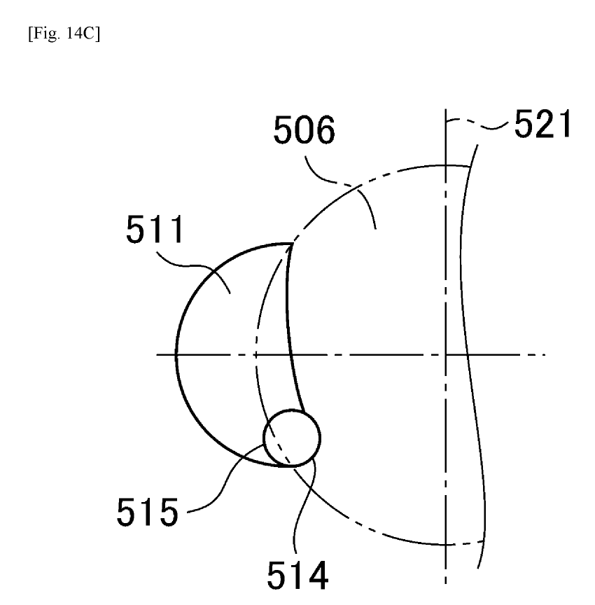

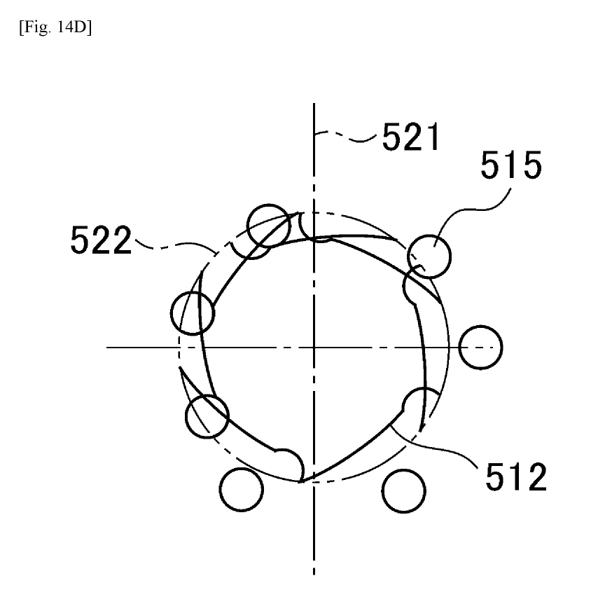

As shown in FIGS. 14(a) to 14(c), the disk-shaped rotor 506 is rotated in the rotational direction. As shown in FIG. 14(b), the counterweight ball 515 in the ball swing box 511 is pressed against an arc-shaped wall surface of the outer edge portion 513 of the ball swing box 511 by the gravitational force and the centrifugal force at a right side of a disk-shaped rotor center vertical line 521 in the drawing. Then, when the disk-shaped rotor 506 is further rotated and the counterweight ball 515 enters a left side of the disk-shaped rotor center vertical line 521 in the drawing, as shown in FIG. 14(c), the counterweight ball 515 is scooped up by the counter-weight ball receiving section 514 of the ball swing box 511 and rotated with the rotor 506. In this way, in the rotating power amplifying apparatus of the fifth example, the counterweight ball 515 is moved along the trajectory of the counterweight ball shown in FIG. 14(d).

As shown by the trajectory of the counterweight ball of FIG. 14(d), the rotational moment exerted on the main shaft of the counterweight ball 515 is larger at a right side of the disk-shaped rotor center vertical line 521 in the drawing than at a left side in the drawing. Accordingly, in the rotating power amplifying apparatus according to the fifth example, as the revolving speed at which the gravitational force of the counterweight ball 515 effectively works is appropriately selected, rotation efficiency of the disk-shaped rotor 506 can be increased and rotating power of the disk-shaped rotor 506 can be largely amplified.

### Sixth Example

FIG. 15(a) is a view showing a rotating power amplifying apparatus 600 according to a sixth example when seen from above, and FIG. 15(b) is a view showing the rotating power amplifying apparatus 600 according to the sixth example when seen from a front side.

The rotating power amplifying apparatus 600 according to the sixth example includes a main shaft 603 serving as a rotating target, a balance weight 611 that is axially supported by the main shaft 603 and rotatable, a main shaft gear 607 axially supported by the main shaft 603 like the balance weight 611, a subsidiary shaft gear 626 axially supported by a subsidiary shaft 625 and meshed with the main shaft gear 607 to transmit rotating power of the subsidiary shaft 625, a spring case 631 and a spring case gear 632 that are axially supported by the subsidiary shaft 625 and rotatable about the subsidiary shaft 625, and an Osmund spring 634 fixed to the subsidiary shaft 625 and the spring case gear 632. The spring case 631 is intermittently rotated by a driving motor 651 via a drive transmission gear 628 and a speed adjustment gear 629.

The rotating power amplifying apparatus 600 according to the sixth example amplifies rotating power, continuously generates electric power and improves power generation efficiency of electric power obtained by rotation using a configuration in which the Osmund spring 634 is wound and squeezed by falling power and rotating power of the balance weight 611 and rotating power of unwinding of the spring 634 is used as lifting power of the balance weight 611.

The rotating power amplifying apparatus according to the sixth example will be further described below.

In the rotating power amplifying apparatus 600 according to the sixth example, the main shaft 603 serving as a central axis of the rotating body is horizontally installed at a frame 601 via a bearing. The balance weight 611, a balance weight arm 612 and the main shaft gear 607 are axially supported by the main shaft 603. The main shaft 603 is used to add starting torque to the apparatus of the example and extract shaft output.

The balance weight 611 is formed of a material having weight. In the example, the balance weight 611 is formed of, for example, iron.

The main shaft gear 607 is meshed with the subsidiary shaft gear 626 axially supported by the subsidiary shaft 625. The subsidiary shaft 625 is horizontally installed at the frame 601 via a bearing b 622.

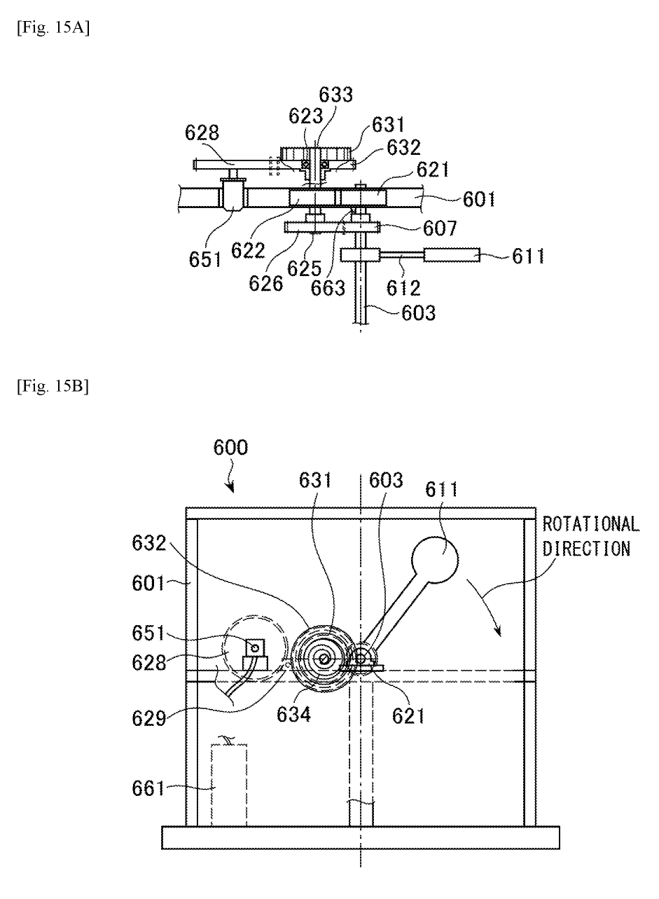

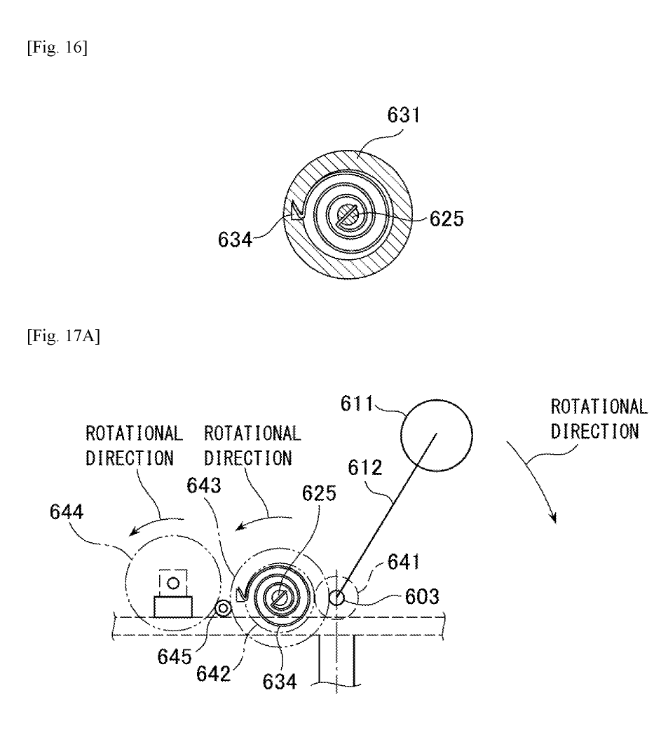

FIG. 16 shows an attachment structure of the Osmund spring 634. The Osmund spring 634 is received in the spring case 631. A core section of the Osmund spring 634 is fixed to the subsidiary shaft 625, and an outer circumferential end of the Osmund spring 634 is fixed to the spring case 631. In addition, the spring case 631 and the spring case gear 632 are rotatably attached via a bearing 623 using the subsidiary shaft 625 as a central axis.

The spring case gear 632 is intermittently rotated by the driving motor 651 via the drive transmission gear 628 and the speed adjustment gear 629. The driving motor 651 connects to a motor control box 661 via a wire. In addition, a rotation sensor 663 configured to detect rotation of the main shaft 603 also connects to the motor control box 661.

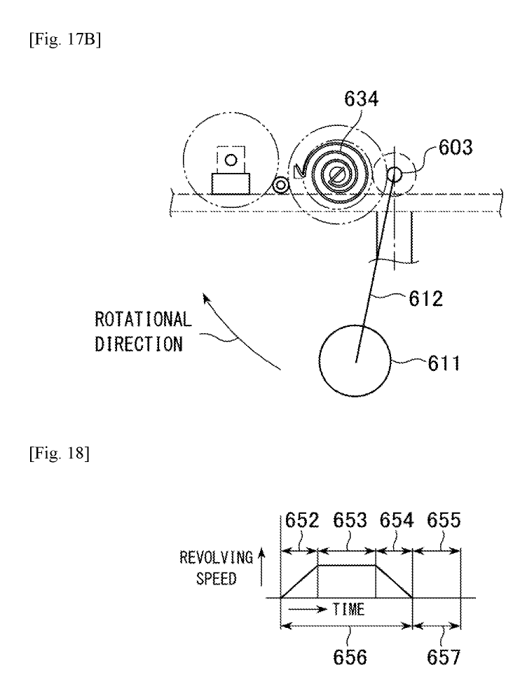

FIGS. 17(a) and 17(b) show an operation principle of the rotating power amplifying apparatus according to the sixth example. FIG. 17(a) shows a state in which the spring case gear 632 is synchronized and rotated with the balance weight 611, and FIG. 17(b) shows a state in which the spring case 631 is stopped and the Osmund spring 634 installed in the spring case 631 is wound and squeezed.

In the rotating power amplifying apparatus 600 according to the sixth example, a position of the balance weight 611 upon starting is preferably a position of the balance weight 611 shown in FIG. 17(a) in a state in which the spring case gear 632 is synchronized and rotated with the balance weight 611. The spring case 631 preferably starts from a state in which the spring case 631 is wound by the driving motor 651 one to two turns and a repellent force is accumulated in the Osmund spring 634.

In the rotating power amplifying apparatus 600 according to the sixth example, it is preferable to generate a wheel axis effect and reduce a load applied to the driving motor 651 using a relation of gear reference pitch diameters represented as the spring case gear 632>the subsidiary shaft gear 626>the main shaft gear 607.

In the rotating power amplifying apparatus according to the sixth example, the driving motor is controlled in sequence of an acceleration zone, a constant speed zone and a deceleration zone while the balance weight is rotated a plurality of times, and further, rotation of the driving motor is stopped and electrical conduction is minimized at the same time. In the example shown in FIGS. 15 to 18, for example, the driving motor 651 is controlled in sequence of the acceleration zone, the constant speed zone and the deceleration zone while the balance weight 611 is rotated two turns. Then, continuously, at a third turn of the balance weight 611, rotation of the driving motor 651 is stopped and electrical conduction is minimized at the same time. In the rotating power amplifying apparatus of the example, the driving motor 651 is operated by repeating the cycles.

FIG. 18 shows control of the motor and movement of the balance weight when a stepping motor is used as the driving motor 651. Further, while the example in which the stepping motor is used as the driving motor 651 has been described here, the driving motor 651 may be, for example, a servo motor.

A state in which the spring case gear 632 is synchronized and rotated with the balance weight 611 as shown in FIG. 17(a) represents a constant speed zone 653 of movement of the motor and the balance weight as shown in FIG. 18. A spring case stoppage state shown in FIG. 17(b) represents a rotation stoppage/electric conduction minimum zone 655 of the motor and the balance weight shown in FIG. 18.

The rotation stoppage/electric conduction minimum zone 655 of the driving motor 651 is preferably synchronized with a section in which a rotational moment is maximally effective due to dropping of the balance weight 611.

From a deceleration zone 654 to the rotation stoppage/electric conduction minimum zone 655 of the driving motor 651, the Osmund spring 634 is wound and squeezed by a rotational speed difference. In a region in which the rotational moment caused by the balance weight 611 is against rotation of the main shaft, rotation of the balance weight 611 is promoted by a resultant force of a repellent force of the Osmund spring 634 and rotating power of the driving motor 651 in an acceleration zone 652.

In addition, the rotation sensor 663 may be installed at a periphery of the main shaft 603. Since the revolving speed of the balance weight 611 and the main shaft 603 and rotation of the spring case gear 632 are synchronized, rotation of the driving motor 651 can be controlled by a program incorporated in the motor control box 661.

As described above, a winding/squeezing repellent force of the spring is used at the position at which the balance weight generates a rotational moment against the rotational direction. In addition, in the stoppage zone of the driving motor, due to synchronization with the section in which the rotational moment due to dropping of the balance weight 611 is large, the balance weight 611 can maintain the rotating power in a state in which there is no input from the driving motor 651. Accordingly, in the rotating power amplifying apparatus of the example, since the balance weight can maintain the rotating power even in a state in which there is no input from the driving motor due to synchronization with the section in which the rotational moment is large during continuous rotation of the main shaft, more effective power generation efficiency can be achieved.

By arbitrarily combining the rotating power amplifying apparatuses according to the first to sixth examples, it is possible to obtain the rotating power amplifying apparatus capable of increasing rotation efficiency of the main rotating body and largely amplifying rotating power of the main rotating body. That is, it is possible to provide a rotating power amplifying apparatus capable of substantially continuously generating electric power and remarkably improving power generation efficiency of electric power obtained by rotation while applying little starting energy.

By providing the configuration of the rotating power amplifying apparatus according to the example, it is possible to obtain a rotary power generating apparatus capable of extracting rotating power from a main rotating body.

By providing the configuration of the rotating power amplifying apparatus according to the example, it is possible to obtain a generator capable of extracting output from a main rotating body and generating power.

1-17. (canceled)

18. A rotating power amplifying apparatus comprising:
a main shaft having a horizontally installed central axis;
a main rotating body supported by the main shaft and rotatable about the central axis of the main shaft; and
a repellent force generating mechanism installed around the central axis, having a repellent force generating member displaceable around the central axis, configured to displace the repellent force generating member and generate a repellent force by rotation of the main rotating body, and configured to rotate the main rotating body.

19. The apparatus according to claim 18, wherein the main rotating body comprises at least one balance weight rotatable about the central axis.

20. The apparatus according to claim 18, wherein the repellent force generating mechanism comprises a first magnet and a second magnet serving as the repellent force generating member and disposed concentric with each other around the central axis of the main shaft, a relative position between the first magnet and the second magnet is displaced in the rotational direction of the main rotating body by rotation of the main rotating body, and a repellent force is generated by a repulsive force generated between the first magnet and the second magnet.

21. The apparatus according to claim 20, wherein the first magnet is installed at the main rotating body in a fan shape on a circle concentric with the central axis and rotated with the main shaft in a predetermined direction, and the second magnet is installed at a magnet holder in a fan shape on a circle concentric with the central axis at positions at which the first magnet is held when the first magnet is rotated in a predetermined direction and reaches a predetermined position at which a rotational moment opposite to a rotational moment of the main rotating body is generated.

22. The apparatus according to claim 20, wherein the first magnet is a permanent magnet and the second magnet is an electromagnet.

23. The apparatus according to claim 20, wherein both the first magnet and the second magnet are permanent magnets.

24. The apparatus according to claim 18, wherein the repellent force generating mechanism comprises a spring serving as the repellent force generating member, the spring is displaced by rotation of the main rotating body, and a repellent force is generated by the displaced spring.

25. The apparatus according to claim 24, wherein the repellent force generating mechanism comprises a coil spring in which a center of a spiral section coincides with the central axis of the main shaft.

26. The apparatus according to claim 25, wherein the repellent force generating mechanism comprises a cam mechanism, and the coil spring is wound and squeezed or released.

27. The apparatus according to claim 26, wherein the cam mechanism comprises a gear, a cam and a cam rod.

28. The apparatus according to claim 18, comprising:
a driving gear that rotates about the central axis of the main shaft;
a fixed gear fixed to the main shaft;
a planetary gear that rotates about a central axis different from the central axis of the main shaft;
a balance weight supported by a balance weight arm supported by a central axis of the planetary gear and rotating about the central axis of the planetary gear; and
a gear case integrally fixed to the driving gear and configured to house the fixed gear and the planetary gear.

29. The apparatus according to claim 28, wherein
the fixed gear and the planetary gear have the same tooth structure, and
an attachment angle of the balance weight arm with respect to the central axis of the planetary gear is not varied, regardless of the position at which the gear case is disposed.

30. The apparatus according to claim 18, wherein the main rotating body comprises a partition spring therein and has a ball movement box having an elliptical shape and configured to house a counterweight ball.

31. The apparatus according to claim 18, wherein the main rotating body has a ball swing box having an arcuate shape and configured to house a counterweight ball, and the counterweight ball is temporarily held in a concave section formed in the arcuate shape.

32. The apparatus according to claim 18, wherein an Osmund spring is installed at a subsidiary shaft different from the main shaft.

33. A rotary power generating apparatus comprising:
the apparatus according to claim 18; and
a rotating power output apparatus connected to the main rotating body and configured to output rotating power according to rotation of the main rotating body.

34. A generator comprising:
the apparatus according to claim 18; and
a power generating apparatus connected to the main rotating body and configured to generate electric power according to rotation of the main rotating body.
